(19) United States
(12) Patent Application Publication
(10) Pub. No.: US 2026/0004282 A1
(43) Pub. Date: Jan. 1, 2026

(54) TOKEN SERVICES FOR NON-FUNGIBLE TOKENS

(71) Applicant: Visa International Service Association, San Francisco, CA (US)

(72) Inventors: Smitha Shankar, London (GB); Marta Waszczuk, Warszawa (PL)

(73) Assignee: Visa International Service Association, San Francisco, CA (US)

(21) Appl. No.: 18/880,629

(22) PCT Filed: Jun. 29, 2023
(86) PCT No.: PCT/US2023/069336

§ 371 Date: Jan. 2, 2025

Related U.S. Application Data
(60) Provisional application No. 63/367,647, filed on Jul. 5, 2022.

(51) Int. Cl. G06Q 20/36; G06Q 20/02; G06Q 20/40; G06Q 30/018

(52) U.S. Cl. CPC G06Q 20/3674; G06Q 20/02; G06Q 20/4014; G06Q 30/018

(57) ABSTRACT

A token processing server computer to process tokens for non-fungible tokens is disclosed. The token processing server computer includes a processor and a memory coupled to the processor. The memory stores machine executable instructions that when executed by the processor cause the processor to issue a token identification (ID) based on a non-fungible token (NFT) and authenticate ownership of the NFT using payment rails.

### CROSS-REFERENCE TO RELATED APPLICATIONS

The present application claims priority to U.S. Provisional Patent Application No. 63/367,647, titled TOKEN SERVICES FOR NON-FUNGIBLE TOKENS, filed Jul. 5, 2022, the disclosure of which is hereby incorporated by reference in its entirety.

### TECHNICAL FIELD

At least some aspects of the present disclosure relate to electronic token services for non-fungible tokens (NFTs).

### BACKGROUND

An NFT is a unit of data, stored on a type of digital ledger called a blockchain, which can be sold and traded. An NFT can be associated with a particular digital or physical asset including but not limited to, art, songs, and sport highlights and a license to use the asset for a specified purpose such as a special event. There are at least three unaddressed concerns with NFTs. First, the process for redeeming NFT experiences is complicated. Second, it is difficult to identify fake NFTs. Third, it is challenging to establish ownership of NFTs.

NFTs have opened up new ways of brand storytelling and consumer interaction. The experience of validating and accessing experiences linked to these NFTs, however, have not kept pace with the progress. The experience of NFT redemption in the real world is not frictionless enough to appeal to the digital native population. Validation of the authenticity of the NFTs or the authorship might be a challenge because of fake NFTs, forgery, unsolicited use of art, time taken to validate an NFT on a block chain, among others. Further, the many steps necessary to prove the ownership makes it hard to scale to large audiences, especially non-crypto savvy or other use cases. For example, for viewing an NFT transaction using Etherscan.io, the following four steps must be followed, which takes a few minutes at least:
1. Go to Etherscan.io and enter your wallet address into the search bar.
2. Select the desired tokens you want to view.
3. Choose the specific transaction hash (NFT) you want to view.
4. Verify your NFT's ‘Status’ and ‘Tokens Transferred’.

Presently, there is not an effective way for people to authenticate their NFTs off-chain. There also is not a fool proof way to ensure legitimacy of an NFT unless you know how to read the NFT smart contract details.

As applications for NFTs begin to include collectibles, land records, security collateral etc., there is a pressing need for a way to verify the ownership and legitimacy of an NFT in a fast and secure manner. The present disclosure provides a solution that leverages token service capabilities to bring together an ecosystem where anyone can efficiently establish ownership and authenticity of the token anywhere.

### SUMMARY

In one aspect, the present disclosure describes a token processing server for processing non-fungible tokens, the token processing server comprising: a processor; and a memory coupled to the processor, the memory storing machine executable instructions that when executed by the processor, cause the processor to: issue a token ID based on metadata of a non-fungible token (NFT); and authenticate ownership of the NFT using payment rails in response to an access request of the NFT.

In another aspect, the present disclosure describes an off-chain token processing server for off-chain authentication of non-fungible tokens generated on a blockchain, the off-chain token processing server comprising: a processor; and a memory coupled to the processor, the memory storing machine executable instructions that when executed by the processor cause the processor to: generate an off-chain token ID based on an identification characteristic of the NFT; store the off-chain token ID in a token vault coupled to the processor, wherein the token vault comprises a mapping for the token ID to the NFT; and authenticate the NFT based on the off-chain token.

In yet another aspect, the present disclosure describes a method for processing non-fungible token (NFT), the method comprising: receiving, by a token processing server, a request to generate an off-chain token ID for an NFT, from an NFT marketplace computer in response to a purchase of the NFT; issuing, by the token processing server, the off-chain token ID based on metadata of the NFT; receiving, by the token processing server, an authentication request generated by a point of access computer; authenticate, by the token processing server, ownership of the NFT based on information from a token vault associated with the token processing server; and providing, by the token processing server, an authentication decision to the point of access computer based on the off-chain token ID.

Payment products include, for example, payment cards such as credit cards, debit cards, prepaid cards, digital wallets, etc., and managing electronic tokens associated with various entities (e.g., users of a transactional token processing system) involved in these transactions (e.g., using transaction data obtained during this processing, such as by a transaction handler). In one example, each of the tokens may be employed to verify the ownership and legitimacy of an NFT.

### FIGURES

Various features of the embodiments described herein, together with advantages thereof, may be understood in accordance with the following description taken in conjunction with the accompanying drawings as follows:

FIG. 1 is a diagram illustrating a financial services company providing a token processing server acting as a bridge between existing commerce and NFT commerce, according to at least one aspect of the present disclosure.

FIG. 2 is a logic flow diagram of a method of providing token services for NFTs, according to at least one aspect of the present disclosure.

FIG. 3 is a system for issuing a token ID based on an NFT, according to at least one aspect of the present disclosure.

FIG. 4 is a system for authenticating ownership of an NFT using payment rails, according to at least one aspect of the present disclosure.

FIG. 5 is a logic flow diagram of a method for issuing a token ID based on metadata for an NFT, according to at least one aspect of the present disclosure.

FIG. 6 is a logic flow diagram of a method for authenticating ownership of an NFT using payment rails, according to at least one aspect of the present disclosure.

FIG. 7 is a logic flow diagram of a method of delivering a seamless experience for authenticating an NFT that grants access to a special event for the NFT owner, according to at least one aspect of the present disclosure.

FIG. 8 shows a block diagram of a computer apparatus according to at least aspect of the present disclosure.

Corresponding reference characters indicate corresponding parts throughout the several views. The exemplifications set out herein illustrate various embodiments of the invention, in one form, and such exemplifications are not to be construed as limiting the scope of the invention in any manner.

### DESCRIPTION

Applicant of the present application owns the following U.S. Patents and Patent Application Publication, the disclosure of each of which is herein incorporated by reference in its respective entirety:
U.S. Pat. No. 10,891,610, filed May 31, 2012, entitled LOCAL USAGE OF ELECTRONIC TOKENS IN A TRANSACTION PROCESSING SYSTEM;
U.S. Pat. No. 11,023,890, filed Jun. 5, 2015, entitled IDENTIFICATION AND VERIFICATION FOR PROVISIONING MOBILE APPLICATION;
U.S. Patent Application Publication No. 2016/0148197, filed Nov. 25, 2015, entitled TOKENIZATION REQUEST VIA ACCESS DEVICE; and
U.S. Pat. No. 11,093,936, filed May 8, 2018, entitled SYSTEMS AND METHODS FOR COMMUNICATING TOKEN ATTRIBUTES ASSOCIATED WITH A TOKEN VAULT.

The above patents and patent application publication describe network token systems that provide a platform that can be leveraged by various entities such as third party wallet providers, merchants, acquirers, payment processors, etc. that use tokens to facilitate payment transactions. The network token systems may be adapted and configured to enable an NFT owner to prove ownership and legitimacy of their NFT anywhere using a token.

Before explaining various forms of token services for NFTs, it should be noted that the illustrative forms are not limited in application or use to the details of construction and arrangement of parts illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof.

Before discussing specific embodiments, aspects, or examples, some descriptions of terms used herein are provided below.

A “digital wallet” can include an electronic device that allows an individual to conduct electronic commerce transactions. A digital wallet may be designed to streamline the purchase and payment process. A digital wallet may allow the user to load one or more payment cards onto the digital wallet so as to make a payment without having to enter an account number or present a physical card.

A “digital wallet provider” may include an entity, such as an issuing bank or third party service provider, that issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile device or access device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions.

As used herein, an “electronic wallet,” “digital wallet” or “mobile wallet” can store user profile information, payment information (including tokens), bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device, smart watch) executing an application program and server-side software and/or databases for maintaining and providing transaction data to the user device.

As used herein, the term “electronic wallet provider” may include an entity that provides and/or maintains an electronic wallet and/or an electronic wallet mobile application for a user (e.g., a customer). Examples of an electronic wallet provider include, but are not limited to, Google Wallet™, Android Pay®, Apple Pay®, and Samsung Pay®, and/or other like electronic payment systems. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “electronic wallet transaction processing system” may refer to one or more electronic devices and/or software applications configured to process and/or a request to authenticate a user for a transaction initiated and/or conducted by an electronic wallet application. For example, an electronic wallet transaction processing system may include server-side software and/or databases for maintaining and providing transaction data and/or account data to a merchant system and/or a payment gateway system for processing and/or authenticating a user for an electronic wallet transaction. An “electronic wallet transaction processing system provider” may include an entity that provides and/or maintains an electronic wallet transaction processing system, such as Visa Checkout, Mastercard MasterPass™, PayPal Checkout, and/or other like electronic wallet transaction processing system providers. In some non-limiting examples, a transaction service provider system may be an electronic wallet transaction processing system.

A “token service provider” may refer to an entity including one or more server computers in a token service system that generates, processes and maintains tokens. The token service provider may include or be in communication with a token vault where the generated token IDs are stored. Specifically, the token vault may maintain one-to-one mapping between token IDs and non-fungible tokens (NFTs). Various entities of a tokenization ecosystem may assume the roles of the token service provider. A token service provider may provide reports or data output to reporting tools regarding approved, pending, or declined token requests, including any assigned token requestor IDs. The token service provider may provide data output related to token-based transactions to reporting tools and applications and present the token and/or PAN as appropriate in the reporting output.

A “token service system” refers to a system that facilitates requesting, generating and/or issuing tokens, as well as maintaining an established mapping of non-fungible tokens (NFTs) to token IDs in a repository (e.g. token vault). In some embodiments or aspects, the token service system may establish a token assurance level for a given token to indicate the confidence level of the token to PAN binding. The token service system may support token processing of payment transactions submitted using tokens by de-tokenizing the token to obtain the actual PAN. In various embodiments or aspects, the token service system may include a token requestor and a token service provider interacting with the token requestor. In some embodiments or aspects, a token service system may include a tokenization computer alone, or in combination with other computers such as a transaction processing network computer.

A “token requestor identifier” may include any characters, numerals, or other identifiers associated with an entity associated with a network token system. For example, a token requestor identifier may be associated with an entity that is registered with the network token system. In some embodiments, a unique token requestor identifier may be assigned for each domain for a token request associated with the same token requestor. For example, a token requestor identifier can identify a pairing of a token requestor (e.g., a mobile device, a mobile wallet provider, etc.) with a token domain (e.g., e-commerce, contactless, etc.). A token requestor identifier may include any format or type of information. For example, in one embodiment, the token requestor identifier may include a numerical value such as a ten digit or an eleven digit number (e.g., 4678012345).

In some embodiments, a token requestor identifier may uniquely identify the pairing of a token requestor with a token domain. As such, in some embodiments, if a token requestor may request tokens for multiple domains, the token requestor may have multiple token requestor identifiers, one for each domain.

For example, in some embodiments, a token requestor identifier may include an 11 digit numeric value assigned by the network token system and the token requestor identifier may be unique within the token registry for each entity (and each domain). For instance, the token requestor identifier may include a code for a token service provider (e.g., first 3 digits) such as the network token system and the remaining digits (e.g., last 8 digits) may be assigned by the token service provider for each requesting entity (e.g., mobile wallet provider) and for each token domain (e.g., contactless, e-commerce, etc.).

In some embodiments, a token requestor identifier may be used in a transaction during authorization processing. For example, a token requestor identifier may be passed through a transaction request message to validate that the entity that is initiating the transaction is the same as the entity that requested and manages the token. In some embodiments, an entity (e.g., digital or mobile wallet provider, merchant, merchant of record, payment enabler, etc.) can be assigned a token requestor identifier during an on-boarding or registration process. In some embodiments, an acquirer/acquirer processor/payment enabler (i.e., payment service provider) may populate the token requestor identifier for each merchant, mobile wallet provider, consumer, etc. into the authorization message field prior to submitting the authorization request message to a payment processing network.

A “token vault” may refer to a repository that maintains established mappings. According to various embodiments or aspects, the token vault may also maintain other attributes of the token requestor that may be determined at the time of registration and that may be used by the token service provider to apply domain restrictions or other controls during transaction processing. For example, the token vault may maintain one-to-one mapping between a token and an account identifying number represented by the token. The token vault may be a part of the token service system. In some embodiments or aspects, the token vault may be provided as a part of the token service provider. Alternatively, the token vault may be a remote repository accessible by the token service provider. Token vaults, due to the sensitive nature of the data mappings that are stored and managed in them, may be protected by strong underlying physical and logical security.

In various aspects, the present disclosure provides a token service for NFTs that leverages existing payment rails, tokens, Universal Payment Channels, and Crypto APIs to enable everyone to participate in NFT commerce. In one aspect, a token ID is generated by the token service and returned to the NFT marketplace. The NFT marketplace provides the token ID to a token processing server so that it may be stored off-chain, in a token vault. The off-chain storage allows an NFT owner to quickly and easily provide proof of ownership of their NFT. Additionally, the existing payment rails or payment channels provide a convenient method to facilitate the transfer of money, from the payer and the payee, in exchange for the purchase of an NFT, and the redemption of the NFT. In one aspect, the token may be accessed or redeemed at the point of access (POA) of a merchant and allows the NFT owner and merchant to utilize the existing payment rails and standard hardware (e.g., smartphone with NFT, payment device, etc.), easily adopt NFTs in ecommerce.

In various aspects, the present disclosure provides an effective way for an NFT owner to authenticate their NFTs off-chain, and provide proof of authenticity and/or ownership. The present disclosure also provides a fool proof way to ensure legitimacy of the NFT without knowing how to read the NFT smart contract details. This solution leverages off-chain token service provider capabilities to bring together an ecosystem where anyone can efficiently establish ownership and authenticity of the token anywhere.

Thus, the present disclosure delivers an authentication service to improve NFT commerce. Potential users of the authentication service include merchants, digital wallet service providers, NFT marketplaces, crypto wallet service providers, consumers, among others.

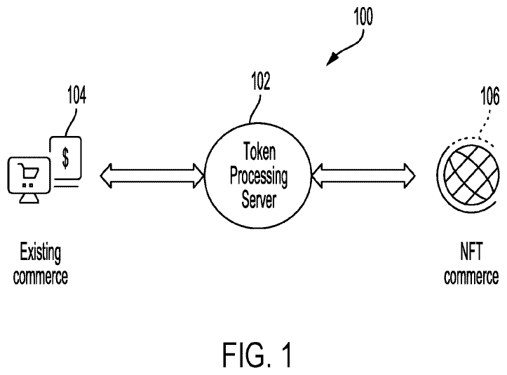

FIG. 1 is a diagram 100 illustrating a financial services company providing a token processing server 102 acting as a bridge between existing commerce 104 and NFT commerce 106, according to at least one aspect of the present disclosure. The financial services company and/or token processing server 102 provides the bridge to enable NFT commerce. The financial services company and/or token processing server 102 is a bridge between on-chain and off-chain communication. The token processing server 102 leverages existing payment rails, existing partnerships and members, token services, payment channels, and crypto APIs, enabling NFT commerce with little to no new hardware changes required for merchants in existing commerce and no new behavior is required of customers.

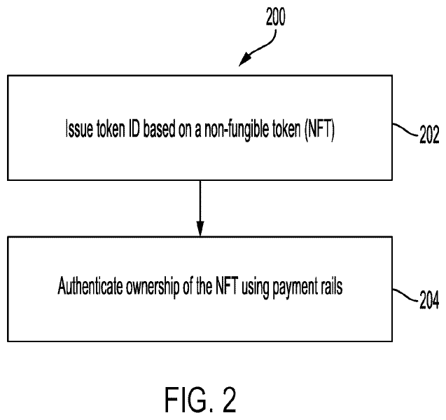

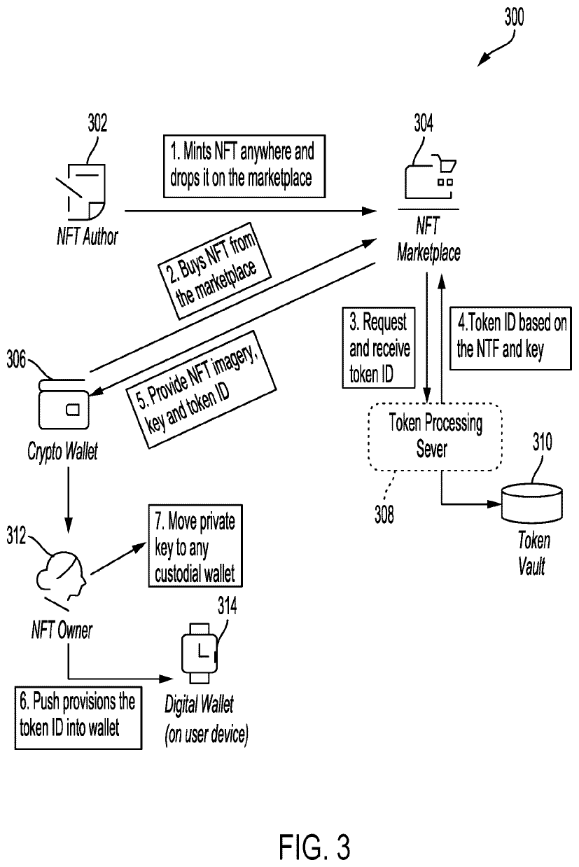

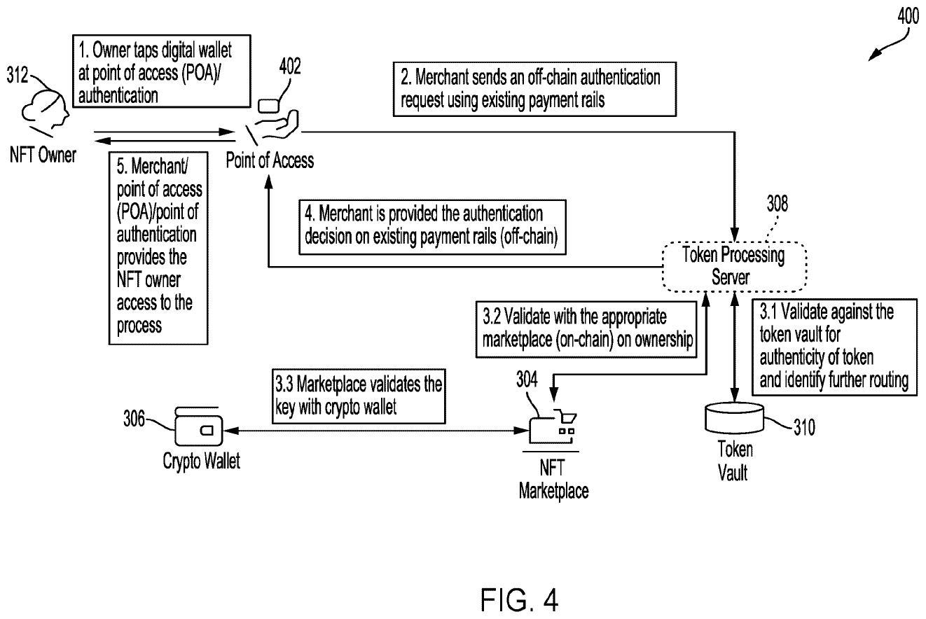

FIG. 2 is a logic flow diagram of a method 200 of providing token services for NFTs, according to at least one aspect of the present disclosure. According to method 200, a token ID is issued 202 based on an NFT. The ownership of the NFT is then authenticated 204 using payment rails. Each of these functions is explained hereinbelow in connection with FIGS. 3 and 4.

FIG. 3 is a system 300 for issuing a token ID based on an NFT, according to at least one aspect of the present disclosure. Initially, the NFT author 302 mints (1) an NFT anywhere and then drops it on the NFT marketplace computer 304. The NFT purchase is initiated (2) with the NFT marketplace computer 304. The NFT marketplace computer 304 requests and receives (3) a token ID from a token processing server 308. The token processing server 308 generates and stores the token ID in a token vault 310 associated with the token processing server 308. In various aspects, the token processing server 308 generates the token ID based on a characteristic of the NFT, such as metadata and/or the public key/private key associated with the NFT. The token processing server 308 provides (4) the token ID, based on an identification characteristic of the NFT, to the NFT marketplace computer 304, in response to the purchase or request. In at least one example, the token processing server 308 provides a token ID based on a public key and/or private key associated with the NFT. It will be appreciated that the token vault 310 maintains a mapping between the NFT and the identification characteristics of the NFT used to generate the token ID. In at least one example, the token processing server 308 provides a token ID based on metadata associated with the NFT. The NFT owner 312 receives (5) the NFT imagery, the private key, and the token ID from the NFT marketplace computer 304, to complete the purchase transaction. The private key corresponds to the public address of the NFT location on the blockchain and allows for on-chain authentication of the NFT ownership. The NFT owner 312 push provisions (6) the token ID into a digital wallet 314. Push provisioning is a generic capability that enables the NFT owner 312 to “push” the token ID from the crypto wallet 306 into a destination wallet 314 or merchant. The NFT owner 312 can move (7) the private key to any custodial wallet. Finally, the NFT owner 312 can access the token ID through the same digital wallet application 314 on their user device. The NFT owner may access the token ID as a way to show proof of ownership or authenticity at a POA. Additionally, a digital wallet mobile app (e.g., X Pay Application) and a reloadable debit card allows the NFT owner 312 to make purchases locally and abroad, pay bills, and send money, through existing payment rails (e.g., credit cards and debit cards).

In one aspect, the token processing server 308 may be implemented as token processing server 308 in network token system shown in FIGS. 2 and 3 and col. 16, line 43 to col. 32, line 2 of U.S. Pat. No. 11,093,936, which is herein incorporated by reference in its respective entirety.

FIG. 4 is a system 400 for authenticating ownership of an NFT using payment rails, according to at least one aspect of the present disclosure. In one aspect, the NFT owner 312 accesses (1) their digital wallet application (e.g. X Pay) at the point of access 402 (POA). In one example, the POA 402 may be a physical merchant computer or point-of-sale terminal that allows the user to communicate with through a short range wireless communication (e.g., NFC, RFID, Bluetooth, etc.). Additionally, the NFT owner 312 may tap a receiver of the POA 402 with their user device to initiate a communication with the POA 402. In another aspect, the NFT owner 312 may use an API to access their digital wallet through a merchant application. The POA computer 402 of the merchant computer may capture data from the user device of the NFT owner 312 when the user device is tapped or waved at the receiver of the POA 402. In one aspect, in an off-chain process, an NFT owner 312 may have registered as a token requestor with the token vault and may have provisioned a token in a wallet application of the user device 314 (e.g., an NFC enabled cell phone). The NFT owner 312 may use the wallet application of the user device 314 to request access to the NFT. The merchant computer 402 may capture a token, a token expiration date, a token cryptogram (or other chip based dynamic cryptogram), and a POS entry mode (as the token presentment mode) from the user device 314. In one embodiment, a token requestor identifier may be encrypted as part of the token and/or chip cryptogram data. The token requestor identifier may correspond to the token ID at the token vault 310.

The merchant computer 402 receives a request from the NFT owner 312 to access their NFT and the merchant computer 402 sends an off-chain authentication request (2) to the token processing server 308 using existing payment rails. The token processing server 308 validates token against token vault 310 for authenticity of token and identifies further routing. The token processing server 308 may validate (3.1) the NFT against the token ID stored in the token vault 310, as described in FIG. 3. In one aspect, the token processing server 308 receives NFT or token information from the POA 402, provided by the NFT owner, and the token processing server 308 authenticates the NFT information against one stored in the token vault 310. If a token ID is not stored in the token vault 310, the token processing server 308 validates (3.2) the authenticity of the NFT at the time of the request, with the appropriate NFT marketplace computer 304, through an on-chain validation of the NFT with the blockchain. The NFT marketplace computer 304 validates (3.2) the public key/private key associated with the NFT blockchain and the NFT owner's crypto wallet 306. In one aspect, the on-chain validation of the NFT may be performed at the time of purchase and the token processing server 308 receives the token. In this aspect, the token ID may be available in the token vault 310 for off-chain authentication at a later time.

Once the validation process is complete, the token processing server 308 provides the merchant computer/POA 402 the authentication decision through the existing payment rails, as an off-chain communication. The merchant computer 402/point of access (POA)/point of authentication computer provides the NFT owner 312 with access to the NFT, for example to an event or process, based on the received authentication decision. In one aspect, the NFT may provide event access. In this aspect, the NTF may provide a more secure method of access over conventional credentials, tickets, or cards.

The authentication time for the on-chain authentication is directly dependent on the underlying block rate of the specific blockchain (e.g., the current block rate for Solana is about 400 milliseconds; the current block rate for Ethereum is about 14 seconds). Once the token processing server receives the on-chain authentication in the form of a token ID, the remaining communications are performed off-chain. The delineation between the on-chain communication and off-chain communication is necessary to leverage the existing payment rails, existing partnerships and members, tokens, payment channels, and crypto APIs. Accordingly, the token processing server allows the NFT platform to be seamlessly integrated with existing customer and merchant hardware. Finally, the use of existing payment rails allows the merchant and customer to perform transactions in a more secure manner without requiring new behavior for customers and merchants. In some instances, the merchant and/or customer may be unaware that the transaction uses an NFT.

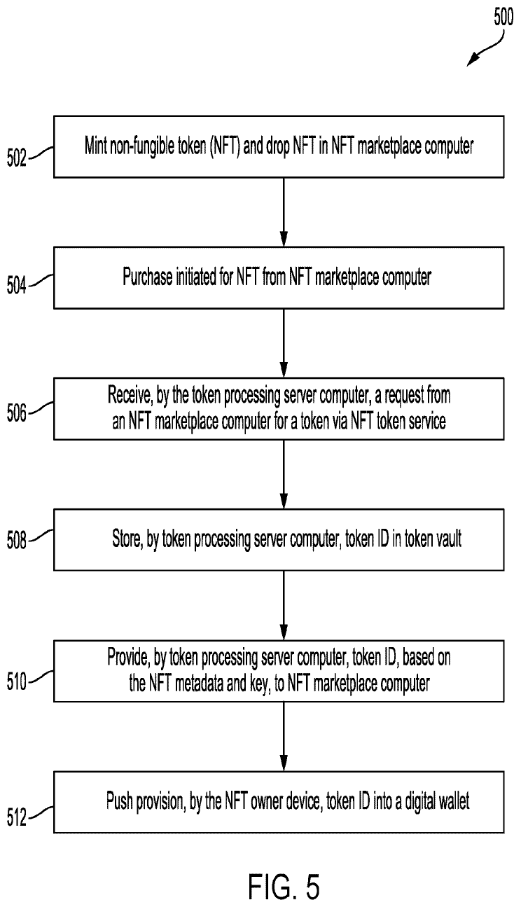

FIG. 5 is a logic flow diagram of a method 500 for issuing a token ID based on metadata for an NFT, according to at least one aspect of the present disclosure. With reference also to FIG. 3, according to the method 500, the NFT author 302 mints 502 an NFT and drops it in the marketplace computer 304. An NFT owner 312 purchases 504 an NFT from the NFT marketplace computer 304. The token processing server 308 receives 506 a request from the NFT marketplace computer 304 to generate a token ID associated with the NFT. The token processing server 308 generates a token ID stores 508 it in a token vault 310. The token processing server 308 provides 510 a token ID to the NFT marketplace computer 304 based on the NFT metadata and/or public key, private key. The NFT owner 312 push provisions 512 the token ID into a digital wallet 314.

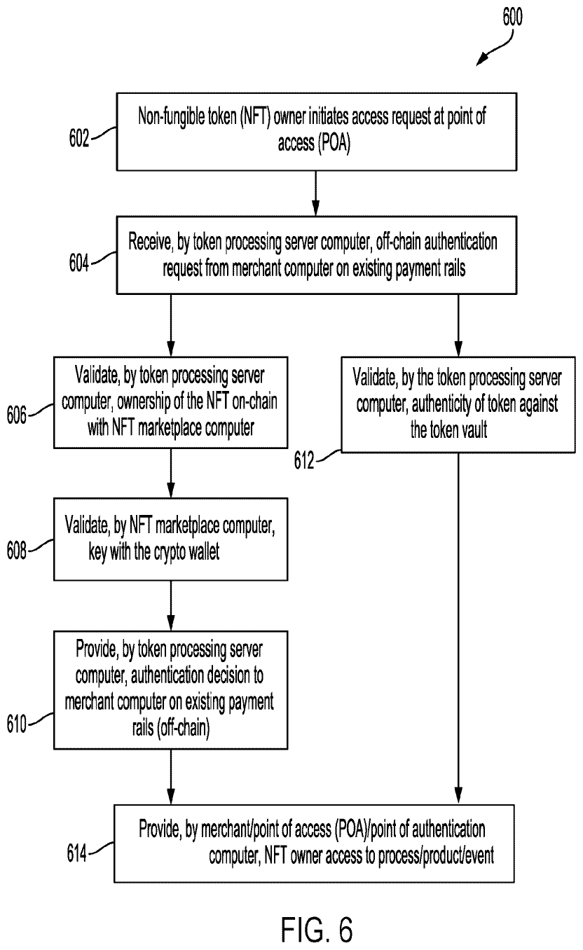

FIG. 6 is a logic flow diagram of a method 600 for authenticating ownership of an NFT using payment rails, according to at least one aspect of the present disclosure. With reference also to FIGS. 3 and 4, according to the method 600, the NFT owner initiates 602 an NFT access request at the point of access 402 (POA). The NFT owner may access their digital wallet through an application on their user device and provide the token ID to the POA through a contactless tap communication. The token processing server 308 receives 604 an off-chain authentication request from the POA/merchant computer 302 on existing payment rails. The token processing server 308 validates 606 ownership of the NFT on-chain with the NFT marketplace computer 304. The NFT marketplace computer 304 validates 608 the public key/private key with the crypto wallet 306. The token processing server 308 provides 614 an authentication decision to the merchant computer 402 on existing payment rails (off-chain). The token processing server 308 validates 612 the authenticity of the token against the token vault 310 and identifies further routing of the token. Additionally, the token processing server 308 provides 614 an authentication decision to the merchant computer 402 on existing payment rails (off-chain).

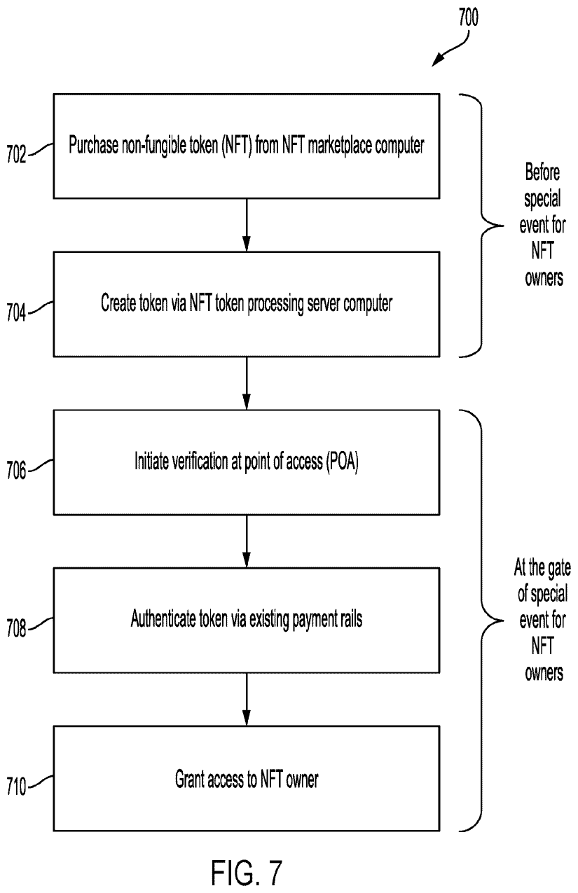

FIG. 7 is a logic flow diagram of a method 700 of delivering a seamless experience for authenticating an NFT that grants access to a special event for the NFT owner, according to at least one aspect of the present disclosure. By way of example, the NFT token acts as a secure and unique key to allow the NFT owner to enter a special event. Before the NFT owners 312 is granted access to the special event, the process includes buying an NFT and creating a token ID associated with the NFT via the NFT token processing server 308. With reference also to FIGS. 3 and 4, according to the method 700, the user becomes an NFT owner 312 by purchasing 702 an NFT on the NFT marketplace through the marketplace computer 304. Also before the event, the NFT token processing server 308 creates 704 a token ID. The NFT marketplace computer 304 sends a request to the token processing server 308 to create a token ID based on the NFT metadata, and after receiving the metadata sends the token ID to the public address of the NFT owner 312 to enable the NFT owner 312 to push provision the token ID to a digital wallet 314.

At the gate of the special event for NFT owners 312, according to the method 700 and still with reference also to FIGS. 3 and 4, the NFT point of access (POA) computer 402 initiates verification of the NFT, authenticates the NFT using existing rails, and grants access to the NFT owner 312 to the special event. At the special event for NFT owners, the NFT owner 312 initiates 706 verification of the NFT at the point of access 402 by tapping the user device with digital wallet application 314 (e.g., a smartwatch) to a POA receiver. The digital wallet application 314 stores the NFT credentials (e.g., token ID) that is provided to the POS terminal/gateway, or any other POA device, so that the NFT owner 312 can pass through the gate. The token ID is then authenticated 708 via existing payment rails. The payment terminal/gateway securely sends data to the token processing server 308 on payment rails. For example, the payment gateway securely sends data (business-as-usual data fields+token data) to the payment processing company on payment rails and the payment processing company then sends that data to the token processing server 308 to determine if the token ID is valid and or/associated with the NFT owner 312. If authentication is successful, the token processing server 308 sends the reply and grants 710 access to the NFT owner 312 to the special event for NFT owners.

The token processing server 308 for NFTs described herein leverages the Unique Selling Proposition of financial services companies and provides a natural extension of business model and strategy. The token processing server 308 for NFTs provides a complex, multi stakeholder touch point ecosystem that cannot easily be replicated in the marketplace. The token s processing server 308 for NFTs can be built upon existing capabilities of network (authorization flow, acceptance network), hardware (terminals) and the same experience customers and merchants are used to (paying with a phone or smartwatch).

The token processing server 308 for NFTs described herein provides advantages of exponential growth of market size: tokenization of all assets+metaverse+mirror worlds +AR. The token processing server 308 for NFTs establishes a central nervous system of the NFT economy provides cross networks settlements (on-chain and off-chain) and enables to play a network of networks role in a decentralized web3.0 world. New use cases are emerging every day e.g., in mass transit/transportation, loyalty and moving quickly into early majority adoption phase.

The primary applications for the token processing server 308 for NFTs described herein include NFT marketplace, software crypto wallet providers, and digital wallets. In the NFT marketplace, the token processing server 308 for NFTs described herein avoids challenges with fake NFTs and enables the top marketplaces (>95% of trade). The benefits include attracting more NFT authors 302 and buyers 312 (e.g., future NFT owner). For software crypto wallet providers, the token processing server 308 for NFTs described herein may be embedded in NFT commerce and enables to top e-wallets. The benefits include avoiding getting disintermediated and the ability to for a partnership to prosper. For digital wallets, the token processing server 308 for NFTs described herein can be used across the marketplace and enables the top wallets and then on a need basis. The benefits include processing a wider share of client's crypto transactions.

Secondary applications include applications applicable to NFT authors 302, NFT owners 312, and point of access 402.

The applications of NFTs and token processing server 308 for NFTs described herein are numerous and evolving. They form a central nervous system of NFT commerce. Near term applications include seamless experience at the point of access 402 (events) for NFT owners 312 to redeem experiences (e.g., concert tickets), validation of the legitimacy of the NFTs and addressing fake NFTs., and settlements between the merchant 402 and NFT author 302 and NFT owner 312 (e.g., $500 value redeemed 10×$50). The latter being application in the mid-term and long-term applications. Mid-term applications include authentication across a wide range of services including government-to-consumer (G2C) (land records), business-to-consumer (B2C) (events, gaming, and loans against NFTs) and inter-operability of crypto wallets across marketplace. Additional applications include. Long-term applications include enabling inter-brand, physical and (immersive) digital experiences across metaverse, augmented reality (AR), and real world.

The various participants and elements described herein with reference to FIGS. 1 and 2 may operate one or more computer apparatuses to facilitate the functions described herein. Any of the elements in FIGS. 1, 3 and 4, including any servers or databases, may use any suitable number of subsystems to facilitate the functions described herein.

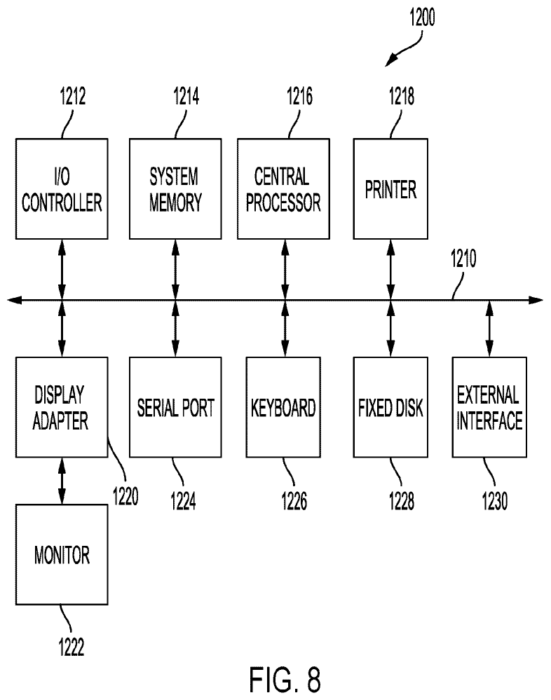

Examples of such subsystems or components are shown in FIG. 8. The subsystems shown in FIG. 8 are interconnected via a system bus 1210. Additional subsystems such as a printer 1218, keyboard 1226, fixed disk 1228 (or other memory comprising computer readable media), monitor 1222, which is coupled to display adapter 1220, and others are shown. Peripherals and input/output (I/O) devices, which couple to I/O controller 1212 (which can be a processor or other suitable controller), can be connected to the computer system by any number of means known in the art, such as serial port 1224. For example, serial port 1224 or external interface 1230 can be used to connect the computer apparatus to a wide area network such as the Internet, a mouse input device, or a scanner. The interconnection via system bus allows the central processor 1216 to communicate with each subsystem and to control the execution of instructions from system memory 1214 or the fixed disk 1228, as well as the exchange of information between subsystems. The system memory 1214 and/or the fixed disk 1228 may embody a computer readable medium.

### EXAMPLES

Examples of the method according to various aspects of the present disclosure are provided below. An aspect of the method may include any one or more than one, and any combination of, the examples described below.

Example 1. A token processing server for processing non-fungible tokens, the token processing server comprising: a processor; and a memory coupled to the processor, the memory storing machine executable instructions that when executed by the processor, cause the processor to: issue a token ID based on metadata of a non-fungible token (NFT); and authenticate ownership of the NFT using payment rails in response to an access request of the NFT.

Example 2. The token processing server of Example 1, wherein to issue the token ID the machine executable instructions when executed cause the processor to: receive a request for the token ID from an NFT marketplace computer, wherein the request is transmitted in response to a purchase of the NFT by a customer; store the token ID in a token vault coupled to the processor, wherein the token vault comprises a mapping for the token ID to the NFT; and provide the token ID, based on the metadata of the NFT and a key associated with a public address of the NFT, to the NFT marketplace computer that returns the token ID to the customer.

Example 3. The token processing server of Example 2, wherein the token ID is issued based on on-chain communication with a blockchain corresponding with the NFT.

Example 4. The token processing server of Examples 1-3, wherein to authenticate ownership of the NFT the machine executable instructions when executed cause the processor to: receive an off-chain authentication request from a merchant computer over the payment rails; bridge off-chain communication by the payment rails with on-chain communication by the NFT marketplace; and validate ownership of the NFT on-chain with NFT marketplace computer, wherein the token ID is associated with an NFT owner of the NFT.

Example 5. The token processing server of Examples 1-4, wherein to authenticate ownership of the NFT the machine executable instructions when executed cause the processor to: validate authenticity of the NFT against the token ID stored in the token vault; and provides an off-chain authentication decision to the merchant computer on the existing payment rails.

Example 6. An off-chain token processing server for off-chain authentication of non-fungible tokens generated on a blockchain, the off-chain token processing server comprising: a processor; and a memory coupled to the processor, the memory storing machine executable instructions that when executed by the processor cause the processor to: generate an off-chain token ID based on an identification characteristic of the NFT; store the off-chain token ID in a token vault coupled to the processor, wherein the token vault comprises a mapping for the token ID to the NFT; and authenticate the NFT based on the off-chain token.

Example 7. The off-chain token processing server of Example 6, wherein the machine executable instructions when executed cause the processor to: receive an off-chain authentication request from a point of access computer, wherein the off-chain authentication request is based on an access request of the NFT; transmit an authentication decision to the point of access computer based on the off-chain token ID.

Example 8. The off-chain token processing server of Example 7, wherein the off-chain authentication request comprises the token ID associated with the NFT.

Example 9. The off-chain token processing server of Example 8, wherein the identification characteristic of the NFT is a key associated with a public address of the NFT.

Example 10. The off-chain token processing server of Example 9, wherein the machine executable instructions when executed cause the processor to perform an on-chain validation of the NFT independent of the point of access computer.

Example 11. The off-chain token processing server computer of Example 10, wherein the authentication decision is further based on the on-chain validation of the NFT.

Example 12. A method for processing non-fungible token (NFT), the method comprising: receiving, by a token processing server, a request to generate an off-chain token ID for an NFT, from an NFT marketplace computer in response to a purchase of the NFT; issuing, by the token processing server, the off-chain token ID based on metadata of the NFT; receiving, by the token processing server, an authentication request generated by a point of access computer; authenticate, by the token processing server, ownership of the NFT based on information from a token vault associated with the token processing server; and providing, by the token processing server, an authentication decision to the point of access computer based on the off-chain token ID.

Example 13. The method of Example 12, further comprising: storing, by the token processing server, the off-chain token ID in the token vault in response to issuing the off- chain token ID.

Example 14. The method of Examples 12-13, wherein the authentication request comprises token information associated with the NFT, wherein the token information is retrieved from a digital wallet.

Example 15. The method of Examples 12-14, wherein the token ID is based on a key associated with a public address of the NFT.

Example 16. The method of Examples 12-15, further comprising: performing, by the token processing server, an on-chain validation of the NFT independent of the point of access computer.

Further, it is understood that any one or more of the following-described forms, expressions of forms, examples, can be combined with any one or more of the other following-described forms, expressions of forms, and examples.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware and/or circuitry configured to perform any of the aforementioned operations.

Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

The above description is illustrative and is not restrictive. Many variations of the invention will become apparent to those skilled in the art upon review of the disclosure. The scope of the present disclosure should, therefore, be determined not with reference to the above description, but instead should be determined with reference to the pending claims along with their full scope or equivalents.

All patents, patent applications, publications, and descriptions mentioned above are herein incorporated by reference in their entirety for all purposes. None is admitted to be prior art.

1. A token processing server for processing non-fungible tokens, the token processing server comprising:
a processor; and
a memory coupled to the processor, the memory storing machine executable instructions that when executed by the processor, cause the processor to:
issue a token ID based on metadata of a non-fungible token (NFT); and
authenticate ownership of the NFT using payment rails based on an access request of the NFT.

2. The token processing server of claim 1, wherein to issue the token ID the machine executable instructions when executed cause the processor to:
receive a request for the token ID from an NFT marketplace computer, wherein the request is transmitted based on a purchase of the NFT by a customer;
store the token ID in a token vault coupled to the processor, wherein the token vault comprises a mapping for the token ID to the NFT; and
provide the token ID, based on the metadata of the NFT and a key associated with a public address of the NFT, to the NFT marketplace computer that returns the token ID to the customer.

3. The token processing server of claim 2, wherein the token ID is issued based on on-chain communication with a blockchain corresponding with the NFT.

4. The token processing server of claim 1, wherein to authenticate ownership of the NFT the machine executable instructions when executed cause the processor to:
receive an off-chain authentication request from a merchant computer over the payment rails;
bridge off-chain communication by the payment rails with on-chain communication by the NFT marketplace; and
validate ownership of the NFT on-chain with NFT marketplace computer, wherein the token ID is associated with an NFT owner of the NFT.

5. The token processing server of claim 1, wherein to authenticate ownership of the NFT the machine executable instructions when executed cause the processor to:
validate authenticity of the NFT against the token ID stored in the token vault; and
provides an off-chain authentication decision to the merchant computer on the existing payment rails.

6. An off-chain token processing server for off-chain authentication of non- fungible tokens generated on a blockchain, the off-chain token processing server comprising:
a processor; and
a memory coupled to the processor, the memory storing machine executable instructions that when executed by the processor cause the processor to:
generate an off-chain token ID based on an identification characteristic of the NFT;
store the off-chain token ID in a token vault coupled to the processor, wherein the token vault comprises a mapping for the token ID to the NFT; and
authenticate the NFT based on the off-chain token.

7. The off-chain token processing server of claim 6, wherein the machine executable instructions when executed cause the processor to:
receive an off-chain authentication request from a point of access computer, wherein the off-chain authentication request is based on an access request of the NFT;
transmit an authentication decision to the point of access computer based on the off- chain token ID.

8. The off-chain token processing server of claim 7, wherein the off-chain authentication request comprises the token ID associated with the NFT.

9. The off-chain token processing server of claim 8, wherein the identification characteristic of the NFT is a key associated with a public address of the NFT.

10. The off-chain token processing server of claim 9, wherein the machine executable instructions when executed cause the processor to perform an on-chain validation of the NFT independent of the point of access computer.

11. The off-chain token processing server computer of claim 10, wherein the authentication decision is further based on the on-chain validation of the NFT.

12. A method for processing non-fungible token (NFT), the method comprising:
receiving, by a token processing server, a request to generate an off-chain token ID for an NFT, from an NFT marketplace computer based on a purchase of the NFT;
issuing, by the token processing server, the off-chain token ID based on metadata of the NFT;
receiving, by the token processing server, an authentication request generated by a point of access computer;
authenticate, by the token processing server, ownership of the NFT based on information from a token vault associated with the token processing server; and
providing, by the token processing server, an authentication decision to the point of access computer based on the off-chain token ID.

13. The method of claim 12, further comprising:
storing, by the token processing server, the off-chain token ID in the token vault based on issuing the off-chain token ID.

14. The method of claim 12, wherein the authentication request comprises token information associated with the NFT, wherein the token information is retrieved from a digital wallet.

15. The method of claim 12, wherein the token ID is based on a key associated with a public address of the NFT.

16. The method of claim 12, further comprising:
performing, by the token processing server, an on-chain validation of the NFT independent of the point of access computer.
